(19) United States
(12) Patent Application Publication
(10) Pub. No.: US 2014/0015933 A1
(43) Pub. Date: Jan. 16, 2014

(54) IMAGE PROCESSING APPARATUS, IMAGING SYSTEM, AND IMAGE PROCESSING SYSTEM

(71) Applicants: Kazuyuki Sato, Yokohama-shi (JP); Takuya Tsujimoto, Kawasaki-shi (JP); Minoru Kusakabe, Yokohama-shi (JP)

(72) Inventors: Kazuyuki Sato, Yokohama-shi (JP); Takuya Tsujimoto, Kawasaki-shi (JP); Minoru Kusakabe, Yokohama-shi (JP)

(73) Assignee: CANON KABUSHIKI KAISHA, Tokyo (JP)

(21) Appl. No.: 14/005,917

(22) PCT Filed: Mar. 6, 2012
(86) PCT No.: PCT/JP2012/001520

§ 371 Date: Sep. 18, 2013

(30) Foreign Application Priority Data
Mar. 30, 2011 (JP) 2011-074603

(51) Int. Cl. H04N 13/02; G02B 21/36

(52) U.S. Cl. CPC H04N 13/0203; G02B 21/36
USPC 348/46

(57) ABSTRACT

An image processing apparatus includes: an image acquisition unit for acquiring original images obtained by imaging an object at different focal positions; an image generation unit for generating a plurality of observation images from the original images, the observation images being mutually different in at least either focal position or DOF; and an image displaying unit for displaying the observation images on a display device. The image generation unit generates the observation images by performing combine processing for selecting two or more original images from the original images and focus-stacking the selected original images to generate a single observation image, for plural times while differing a combination of the selected original images. The image displaying unit selects the observation images to be displayed, when the observation images displayed on the display device are switched, such that the focal position or the DOF changes sequentially.

### TECHNICAL FIELD

This invention relates to an image processing apparatus, an imaging system, and an image processing system, and in particular to a technique for assisting observation of an object with the use of a digital image.

### BACKGROUND ART

Recently, a virtual slide system attracts attention in the field of pathology, as a successor to an optical microscope which is currently used as a tool for pathological diagnosis. The virtual slide system enables pathological diagnosis to be performed on a display by imaging a specimen to be observed placed on a slide and digitizing the image. The digitization of pathological diagnosis images with the virtual slide system makes it possible to handle conventional optical microscope images of specimens as digital data. It is expected this will bring about various merits, such as more rapid remote diagnosis, provision of information to patients through digital images, sharing of data of rare cases, and more efficient education and training.

When using a virtual slide system, it is required to digitize an entire image of a specimen to be observed placed on a slide in order to realize equivalent performance to that of an optical microscope. The digitization of the entire image of the specimen makes it possible to examine the digital data generated with the virtual slide system by using viewer software running or a PC or work station. The digitized entire image of the specimen will generally constitute an enormous amount of data, from several hundred million pixels to several billion pixels when represented by the number of pixels.

Even though the amount of data generated by the virtual slide system is enormous, this makes it possible to examine the specimen image either microscopically (in enlarged detail views) or macroscopically (in overall perspective views) by scaling the image with the viewer, which provides various advantages and conveniences. All the necessary information can be preliminarily acquired so that images of any resolution and any magnification can be displayed instantaneously as requested by a user.

Even though the virtual slide system provides various advantages and conveniences, it still falls short of the conventional optical microscopic observation at some points in convenience in use.

One of such shortcomings resides in observation in a depth direction (a direction along the optical axis of an optical microscope or a direction perpendicular to the observation surface of a slide). In general, when a physician examines a specimen with an optical microscope, he/she minutely moves the microscope stage in a direction of the optical axis to change the focal position in the specimen so that a three-dimensional structure of a tissue or cell can be comprehended. When the same operation is to be done with a virtual slide system, an image is captured at a certain focal position, and then another image must be captured after changing the focal position (for example, by shifting a stage on which a slide is placed in a direction of the optical axis).

Techniques as described below are proposed as methods for processing and displaying a plurality of images captured by repeating image capturing while changing the focal position. Patent Literature (PTL) 1 discloses a system in which each of a plurality of images at different focal positions is divided into a plurality of sections, and focus stacking is performed for each section, whereby a deep-focus image having a deep depth of field is generated.

### CITATION LIST

### Patent Literature

### [PTL 1]

Japanese Patent Application Laid-Open No. 2005-037902

### SUMMARY OF INVENTION

According to the method described in PTL 1, an image focused over the entire range and with little blur can be obtained, and thus a merit is provided that it can be comprehended the condition of the object as a whole with only one image. However, although such deep-focus image is useful for rough observation of the object as a whole, it is not suitable for detailed observation of a part of the object or comprehension of the three-dimensional structure of the object. This is because information in the depth direction (information on a front-and-back relationship) has been lost due to the focus stacking of a great number of images.

This invention has been made in view of these problems, and provides a technology for assisting detailed observation of an object in a depth direction when the object is observed using digital images.

The present invention in its first aspect provides an image processing apparatus including: an image acquisition unit for acquiring a plurality of original images obtained by imaging an object at different focal positions; an image generation unit for generating a plurality of observation images from the plurality of original images, the observation images being mutually different in at least either focal position or depth of field; and an image displaying unit for displaying the observation images on a display device, wherein: the image generation unit generates the plurality of observation images by performing combine processing for selecting two or more original images from the plurality of original images and focus-stacking the selected original images to generate a single observation image, for a plurality of times while differing a combination of the selected original images; and the image displaying unit selects the observation images to be displayed, when the observation images displayed on the display device are switched, such that the focal position or the depth of field changes sequentially.

The present invention in its second aspect provides an image processing apparatus including: an image acquisition unit for acquiring a plurality of original images obtained by imaging an object at different focal positions; an image generation unit for generating a plurality of observation images from the plurality of original images; and an image displaying unit for displaying the observation images on a display device, wherein the image generation unit generates the plurality of observation images by performing combine processing for selecting two or more original images from the plurality of original images and focus-stacking the selected original images to generate a single observation image, for a plurality of times while differing a combination of the selected original images, and determines a combination of the selected original images such that the plurality of observation images have the same focal position and mutually different depths of field.

The present invention in its third aspect provides an imaging system including: an imaging apparatus for generating a plurality of original images by imaging an object at different focal positions; and the above image processing apparatus for acquiring the plurality of original images from the imaging apparatus.

The present invention in its fourth aspect provides an image processing system including: a server for storing a plurality of original images obtained by imaging an object at different focal positions; and the above image processing apparatus for acquiring the plurality of original images from the server.

The present invention in its fifth aspect provides a computer program stored on a non-transitory computer readable medium, the program causing a computer to perform a method including the steps of: acquiring a plurality of original images obtained by imaging an object at different focal positions; generating a plurality of observation images from the plurality of original images, the observation images being mutually different in at least either focal position or depth of field; and displaying the observation images on a display device, wherein: in the step of generating the observation images, the plurality of observation images are generated by performing combine processing for selecting two or more original images from the plurality of original images and focus-stacking the selected original images to generate a single observation image, for a plurality of times while differing a combination of the selected original images; and in the step of displaying the observation images, the observation images to be displayed are selected, when the observation images are switched, such that the focal position or the depth of field changes sequentially.

The present invention in its sixth aspect provides a computer program stored on a non-transitory computer readable medium, the program causing a computer to perform a method including the steps of: acquiring a plurality of original images obtained by imaging an object at different focal positions; generating a plurality of observation images from the plurality of original images; and displaying the observation images on a display device, wherein: in the step of generating the observation images, the plurality of observation images are generated by performing combine processing for selecting two or more original images from the plurality of original images and focus-stacking the selected original images to generate a single observation image, for a plurality of times while differing a combination of the selected original images; and a combination of the selected original images is determined such that the plurality of observation images have the same focal position and mutually different depths of field.

According to this invention, an object can be observed in detail in a depth direction when the object is observed using a digital image.

Further features of the present invention will become apparent from the following description of exemplary embodiments with reference to the attached drawings.

### BRIEF DESCRIPTION OF DRAWINGS

FIG. 1 is an overall view showing a layout of apparatuses in an imaging system according to a first embodiment of the invention.

FIG. 2 is a functional block diagram of an imaging apparatus according to the first embodiment.

FIG. 3 is a conceptual diagram illustrating focus stacking.

FIG. 4 is a conceptual diagram illustrating processing to change the depth of field with a fixed focal position.

FIG. 5 is a flowchart illustrating a flow of image processing according to the first and second embodiments.

FIG. 6 is a flowchart illustrating a flow of combine processing according to the first embodiment.

FIG. 7 is a flowchart illustrating a flow of display processing according to the first embodiment.

FIG. 8A to FIG. 8C are diagrams showing examples of an image display screen according to the first embodiment.

FIG. 9 is a diagram showing an example of a setting screen according to the first embodiment.

FIG. 10 is an overall view illustrating a layout of apparatuses in an image processing system according to a second embodiment.

FIG. 11 is a conceptual diagram illustrating processing to change the depth of field with a fixed focal position.

FIG. 12 is a flowchart illustrating a flow of combine processing according to the second embodiment.

FIG. 13 is a flowchart illustrating a flow of display processing according to the second embodiment.

FIG. 14 is a diagram showing an example of a setting screen according to the second embodiment.

FIG. 15 is a flowchart illustrating a flow of image acquisition according to a third embodiment.

FIG. 16 is a flowchart illustrating a flow of image processing according to the third embodiment.

FIG. 17A and FIG. 17B are diagrams illustrating examples of mode designating screens according to the third embodiment.

FIG. 18 is a diagram illustrating an example of a screen in which images are displayed in a multiple display mode according to the third embodiment.

### DESCRIPTION OF EMBODIMENTS

Exemplary embodiments of this invention will be described with reference to the drawings.

### First Embodiment

(System Configuration)

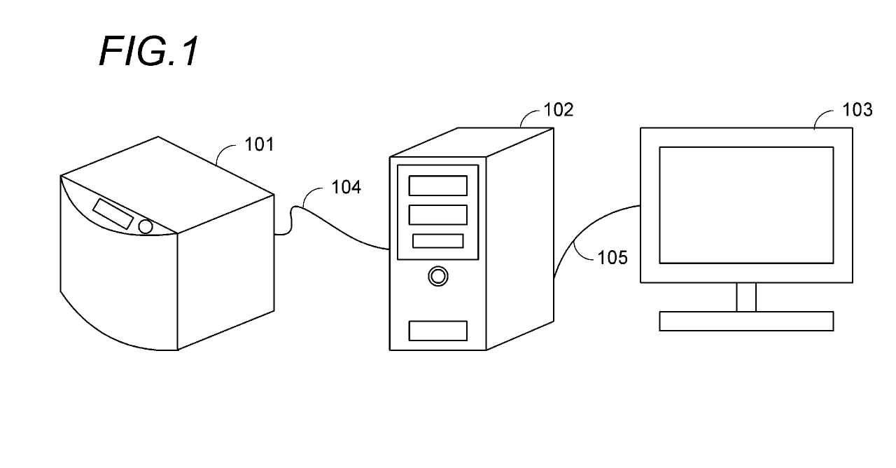

FIG. 1 is an overall view showing a layout of apparatuses in an imaging system according to a first embodiment of the invention.

The imaging system according to the first embodiment is composed of an imaging apparatus (microscope apparatus) 101, an image processing apparatus 102, and a display device 103, and is a system with a function to acquire and display a two-dimensional image of a specimen (object) as an object to be imaged. The imaging apparatus 101 and the image processing apparatus 102 are connected to each other with a dedicated or general-purpose I/F cable 104. The image processing apparatus 102 and the display device 103 are connected to each other with a general-purpose I/F cable 105.

The imaging apparatus 101 is a virtual slide apparatus having a function of acquiring a plurality of two-dimensional images at different focal positions in an optical axis direction and outputting digital images. The acquisition of the two-dimensional images is done with a solid-state imaging device such as a CCD or CMOS. Alternatively, the imaging apparatus 101 may be formed by a digital microscope apparatus having a digital camera attached to an eye piece of a normal optical microscope, in place of the virtual slide apparatus.

The image processing apparatus 102 is an apparatus for assisting a user to do microscopic observation by generating a plurality of observation images, each having a desired focal position and depth of field, from a plurality of original images acquired from the imaging apparatus 101, and displaying those observation images on the display device 103. Main functions of the image processing apparatus 102 include an image acquisition function of acquiring a plurality of original images, an image generation function of generating observation images from these original images, and an image display function of displaying the observation images on the display device 103. The image processing apparatus 102 is formed by a general-purpose computer or work station having hardware resources such as a CPU (central processing unit), a RAM, a storage device, an operation unit, and an I/F. The storage device is a mass information storage device such as a hard disk drive, in which a program for executing processing steps to be described later, data, an OS (operating system) and so on are stored. The above-mentioned functions are realized by the CPU downloading a program and data required for the RAM from the storage device and executing the program. The operation unit is formed by a keyboard or a mouse, and is used by an operator to input various types of instructions. The display device 103 is a monitor which displays a plurality of two-dimensional images as a result of the arithmetic processing done by the image processing apparatus 102, and is formed by a CRT, a liquid-crystal display, or the like.

Although in the example show in FIG. 1, the imaging system consists of three components: the imaging apparatus 101, the image processing apparatus 102, and the display device 103, the invention is not limited to this configuration. For example, the image processing apparatus may be integrated with the display device, or the functions of the image processing apparatus may be incorporated in the imaging apparatus. Further, the functions of the imaging apparatus, the image processing apparatus and the display device can be realized by a single apparatus. Conversely, the functions of the image processing apparatus and the like can be divided so that they are realized by a plurality of apparatuses or devices.

(Configuration of Imaging Apparatus)

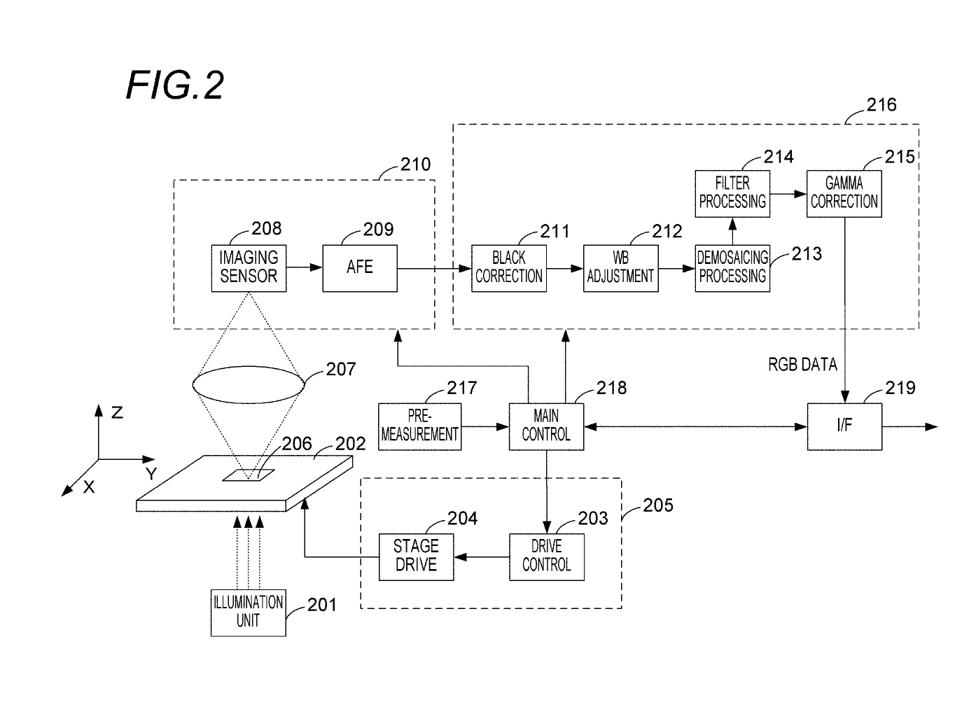

FIG. 2 is a block diagram illustrating a functional configuration of the imaging apparatus 101.

The imaging apparatus 101 is schematically composed of an illumination unit 201, a stage 202, a stage control unit 205, an imaging optical system 207, an imaging unit 210, a development processing unit 216, a pre-measurement unit 217, a main control system 218, and an external interface 219.

The illumination unit 201 is means for irradiating a slide 206 placed on the stage 202 with uniform light, and is composed of a light source, an illumination optical system, and a drive control system for the light source. The stage 202 is drive-controlled by the stage control unit 205, and is movable along three axes of X, Y, and Z. The optical axis direction shall be defined as the Z direction. The slide 206 is a member in which a tissue section or smeared cell to be examined is applied on a slide glass and encapsulated under a cover glass together with an encapsulant.

The stage control unit 205 is composed of a drive control system 203 and a stage drive mechanism 204. The drive control system 203 performs drive control of the stage 202 in accordance with an instruction received from the main control system 218. A direction and amount of movement and so on of the stage 202 are determined based on position information and thickness information (distance information) on the specimen obtained by measurement by the pre-measurement unit 217 and a instruction from the user. The stage drive mechanism 204 drives the stage 202 according to the instruction from the drive control system 203.

The imaging optical system 207 is a lens group for forming an optical image of the specimen in the slide 206 on an imaging sensor 208.

The imaging unit 210 is composed of the imaging sensor 208 and an analog front end (AFE) 209. The imaging sensor 208 is a one-dimensional or two-dimensional image sensor for converting a two-dimensional optical image into an electric physical amount by photoelectric conversion, and a CCD or CMOS, for example is used as the imaging sensor 208. When the imaging sensor 208 is a one-dimensional sensor, a two-dimensional image can be obtained by scanning the image in a scanning direction. The imaging sensor 208 outputs an electrical signal having a voltage value according to an intensity of light. When a color image is desired as a captured image, a single-plate image sensor having a Bayer arrangement color filter attached thereto can be used.

The AFE 209 is a circuit for converting an analog signal output from the imaging sensor 208 into a digital signal. The AFE 209 is composed of an H/V driver, a CDS, an amplifier, an AD converter, and a timing generator as described later. The H/V driver converts a vertical synchronizing signal and horizontal synchronizing signal for driving the imaging sensor 208 into a potential required to drive the sensor. The CDS (correlated double sampling) is a correlated double sampling circuit for removing noise from fixed pattern. The amplifier is an analog amplifier for adjusting gain of the analog signal the noise of which has been removed by the CDS. The AD converter converts an analog signal into a digital signal. When the final stage output of the system has eight bits, the AD converter converts an analog signal into digital data which is quantized to about 10 to 16 bits in consideration of processing to be done in the subsequent stage, and outputs this digital data. The converted sensor output data is referred to as RAW data. The RAW data is subjected to development processing in the subsequent development processing unit 216. The timing generator generates a signal for adjusting timing of the imaging sensor 208 and timing of the subsequent development processing unit 216.

When a CCD is used as the imaging sensor 208, the AFE 209 described above is indispensable. However, when a CMOS image sensor capable of digital output is used as the imaging sensor 208, the sensor includes the functions of the AFE 209. Although not shown in the drawing, an imaging control unit for controlling the imaging sensor 208 is provided. This imaging control unit performs not only control of operation of the imaging sensor 208 but also control of operation timing such as shutter speed, frame rate, and ROI (Region of Interest).

The development processing unit 216 is composed of a black correction unit 211, a white balance adjustment unit 212, a demosaicing processing unit 213, a filter processing unit 214, and a gamma correction unit 215. The black correction unit 211 performs processing to subtract black-correction data obtained during light shielding from each pixel of the RAW data. The white balance adjustment unit 212 performs processing to reproduce desirable white color by adjusting the gain of each color of RGB according to color temperature of light from the illumination unit 201. Specifically, white balance correction data is added to the black-corrected RAW data. This white balance adjustment processing is not required when a monochrome image is handled.

The demosaicing processing unit 213 performs processing to generate image data of each color of RGB from the RAW data of Bayer arrangement. The demosaicing processing unit 213 calculates a value of each color of RGB for a pixel of interest by interpolating values of peripheral pixels (including pixels of the same color and pixels of other colors) in the RAW data. The demosaicing processing unit 213 also performs correction processing (complement processing) for defective pixels. The demosaicing processing is not required when the imaging sensor 208 has no color filter and an image obtained is monochrome.

The filter processing unit 214 is a digital filter for performing suppression of high-frequency components contained in an image, noise removal, and enhancement of feeling of resolution. The gamma correction unit 215 performs processing to add an inverse to an image in accordance with gradation representation capability of a commonly-used display device, or performs gradation conversion in accordance with human visual capability by gradation compression of a high brightness portion or dark portion processing. Since an image is acquired for the purpose of morphological observation in the present embodiment, gradation conversion suitable for the subsequent image combine processing or display processing is performed on the image.

Development processing functions in general include color space conversion for converting an RGB signal into a brightness color-difference signal such as a YCC signal, and processing to compress mass image data. However, in this embodiment, the RGB data is used directly and no data compression is performed.

Although not shown in the drawings, a function of peripheral darkening correction may be provided to correct reduction of amount of light in the periphery within an imaging area due to effects of a lens group forming the imaging optical system 207. Alternatively, various correction processing functions for the optical system may be provided to correct various aberrations possibly occurring in the imaging optical system 207, such as distortion correction for correcting positional shift in image formation or magnification color aberration correction to correct difference in magnitude of the images for each color.

The pre-measurement unit 217 is a unit for performing pre-measurement as preparation for calculation of position information of the specimen on the slide 206, information on distance to a desired focal position, and a parameter for adjusting the amount of light attributable to the thickness of the specimen. Acquisition of information by the pre-measurement unit 217 before main measurement makes it possible to perform efficient imaging. Designation of positions to start and terminate the imaging and an imaging interval when capturing a plurality of images is also performed based on the information generated by the pre-measurement unit 217.

The main control system 218 has a function to perform control of the units described so far. The functions of the main control system 218 and the development processing unit 216 are realized by a control circuit having a CPU, a ROM, and a RAM. Specifically, a program and data are stored in the ROM, and the CPU executes the program using the RAM as a work memory, whereby the functions of the main control system 218 and the development processing unit 216 are realized. The ROM may be formed by a device such as an EEPROM or flush memory, and the RAM may be formed by a DRAM device such as a DDR3.

The external interface 219 is an interface for transmitting an RGB color image generated by the development processing unit 216 to the image processing apparatus 102. The imaging apparatus 101 and the image processing apparatus 102 are connected to each other through an optical communication cable. Alternatively, an interface such as a USB or Gigabit Ethernet (registered trademark) can be used.

A flow of imaging processing in the main measurement will be briefly described. The stage control unit 205 positions the specimen on the stage 202 based on information obtained by the pre-measurement such that the specimen is positioned for imaging. Light emitted by the illumination unit 201 passes through the specimen and the imaging optical system 207 thereby forms an image on the imaging surface of the imaging sensor 208. An output signal from the imaging sensor 208 is converted into a digital image (RAW data) by the AFE 209, and this RAW data is converted into a two-dimensional RGB image by the development processing unit 216. The two-dimensional image thus obtained is transmitted to the image processing apparatus 102.

The configuration and processing as described above enable acquisition of a two-dimensional image of the specimen at a certain focal position. A plurality of two-dimensional images with different focal positions can be obtained by repeating the imaging processing by means of the stage control unit 205 while shifting the focal position in a direction of the optical axis (Z direction). A group of images with different focal positions obtained by the imaging processing in the main measurement shall be referred to as “Z-stack images”, and two-dimensional images forming the Z-stack images at the respective focal positions shall be referred to as the “layer images” or “original images”.

Although the present embodiment has been described in terms of an example in which a single-plate method is used to obtain a color image by means of an image sensor, a three-plate method of obtaining a color image using three RGB image sensors can be used instead of the single-plate method. Alternatively, a triple imaging method can be used in which a single image sensor and a three-color light source are used together and imaging is performed three times while switching the color of the light source.

(Focus Stacking)

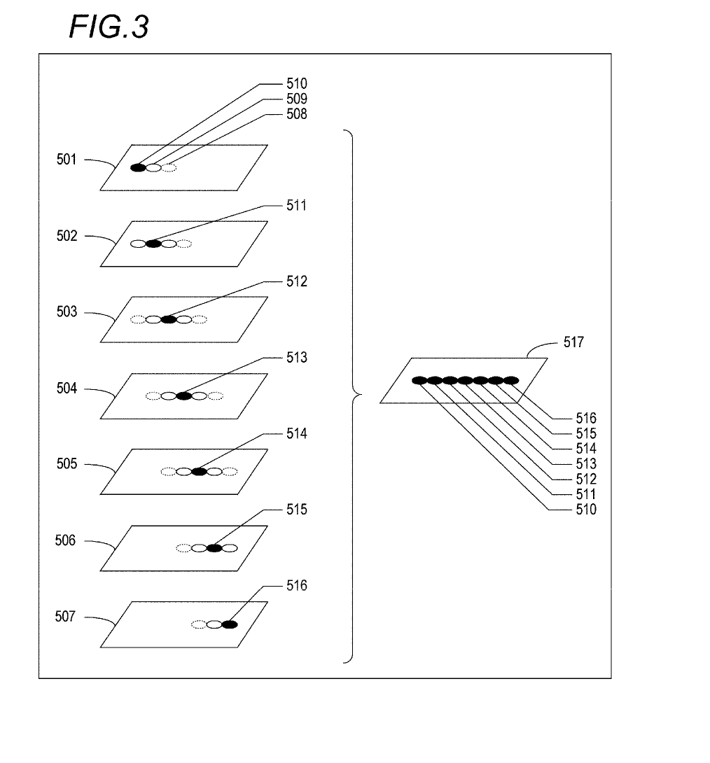

FIG. 3 is a conceptual diagram of focus stacking. The focus stacking processing will be schematically described with reference to FIG. 3.

Images 501 to 507 are seven-layer images which are obtained by imaging seven times an object including a plurality of items to be observed at three-dimensionally different spatial positions while sequentially changing the focal position in the optical axis direction (Z direction). Reference numerals 508 to 510 indicate items to be observed contained in the acquired image 501. The item to be observed 508 comes into focus at the focal position of the image 503, but is out of focus at the focal position of the image 501. Therefore, it is difficult to comprehend the structure of the item to be observed 508 in the image 501. The item to be observed 509 comes into focus at the focal position of the image 502, but is slightly out of focus at the focal position of the image 501. Therefore, it is possible, though not satisfactory, to comprehend the structure of the item to be observed 509 in the image 501. The item to be observed 510 comes into focus at the focal position of the image 501 and hence the structure thereof can be comprehended sufficiently in the image 501.

In FIG. 3, the items to be observed which are blacked out indicate those in focus, the items to be observed which are white indicate those slightly out of focus, and the items to be observed represented by the dashed lines indicate those out of focus. Specifically, the items to be observed 510, 511, 512, 513, 514, 515, and 516 are in focus in the images 501, 502, 503, 504, 505, 506 and 507, respectively. The description of the example shown in FIG. 3 will be made on the assumption that the items to be observed 510 to 516 are located at different positions in the horizontal direction.

An image 517 is an image obtained by cutting out respective regions of the items to be observed 510 to 516 which are in focus in the images 501 to 507 and merging these regions. By merging the focused regions of the plurality of images as described above, a focus-stacked image which is focused in the entirety of the image can be obtained. This processing for generating an image having a deep depth of field by the digital image processing is referred to also as focus stacking or extension of DOF (depth of field).

(Processing for Changing Depth of Field with Fixed Focus)

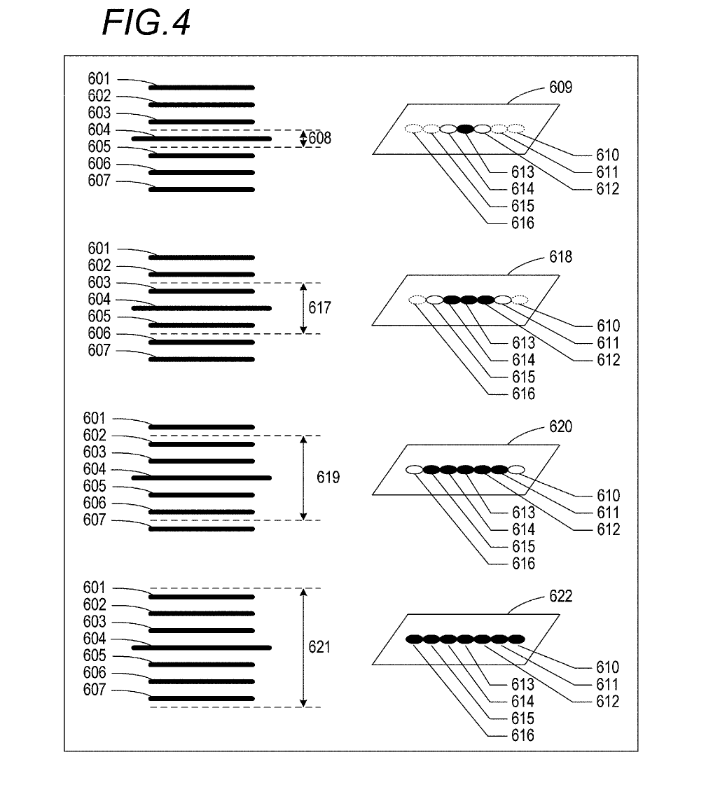

FIG. 4 is a conceptual diagram illustrating a method of realizing, with a virtual slide apparatus, an observation mode in which the depth of field is changed with the focal position fixed. Basic concept of the focus stacking processing that characterizes the present embodiment will be described with reference to FIG. 4.

Focal positions 601 to 607 correspond to the images 501 to 507 in FIG. 3. The focal positions are shifted at the same pitch from 601 to 607 in the optical axis direction. Description will be made of an example in which the focus stacking is performed with the focal position 604 being used as the reference (fixed).

Reference numerals 608, 617, 619 and 621 indicate depths of field after the focus stacking processing has been performed. In this example, the depths of field of the respective layer images are within the range indicated by 608. The image 609 is a layer image at the focal position 604, that is, an image which has not been subjected to the focus stacking. Reference numerals 610 to 616 indicate regions which are in best focus at the focal positions 601 to 607, respectively. In the image 609, the region 613 is in focus, the regions 612 and 614 are slightly out of focus, and the other regions 610, 611, 615 and 616 are totally out of focus.

The reference numeral 617 indicates a deeper depth of field than the reference numeral 608. A combined image 618 is obtained as a result of focus stacking processing performed on three layer images contained in the range of the depth of field 617. In the combined image 618, there are more regions which are in focus than in the image 609, namely the regions 612 to 614 are in focus. As the number of layer images to be used in the combine processing is increased as shown in 619 and 621, the region in focus is expanded in combined images 620 and 622 corresponding thereto. In the combined image 620, the range of the regions 611 to 615 is the region in focus, and in the combined image 622, the range of the regions 610 to 616 is the region in focus.

The images 609, 618, 620, and 622 as described above are generated and displayed while switching them automatically or by the user's operation, whereby observation can be realized while increasing or decreasing the depth of field with the focal position fixed (at 604 in this example). Although in the example shown in FIG. 4, the depth of field is increased/decreased vertically to an equal extent from the focal position, it is also possible to increase/decrease the depth of field only in the upper or lower side the focal position, or to increase/decrease the depth of field to different extents between the upper and lower sides of the focal position.

(Operation of Image Processing Apparatus)

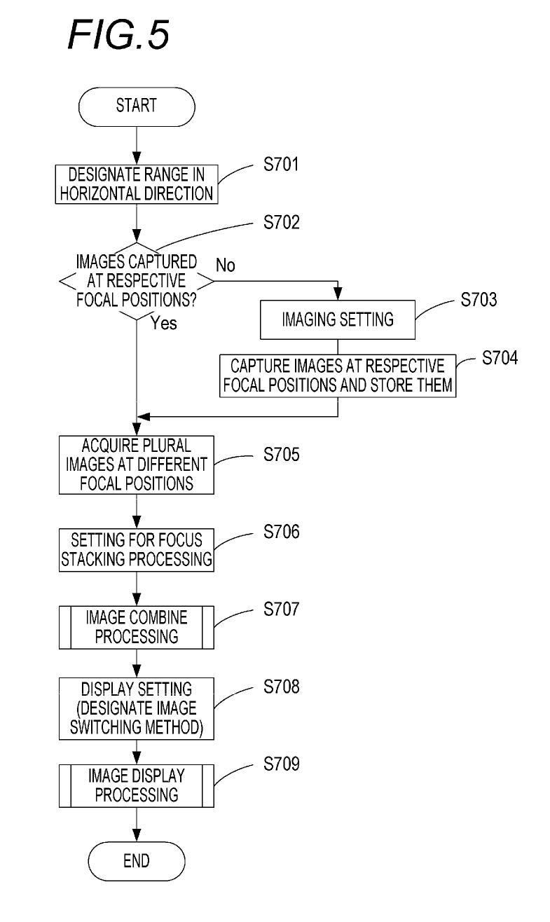

Operation of the image processing apparatus 102 according to the present embodiment will be described with reference to FIGS. 5 to 9. Unless otherwise stated, the processing described below is realized by the CPU of the image processing apparatus 102 executing a program.

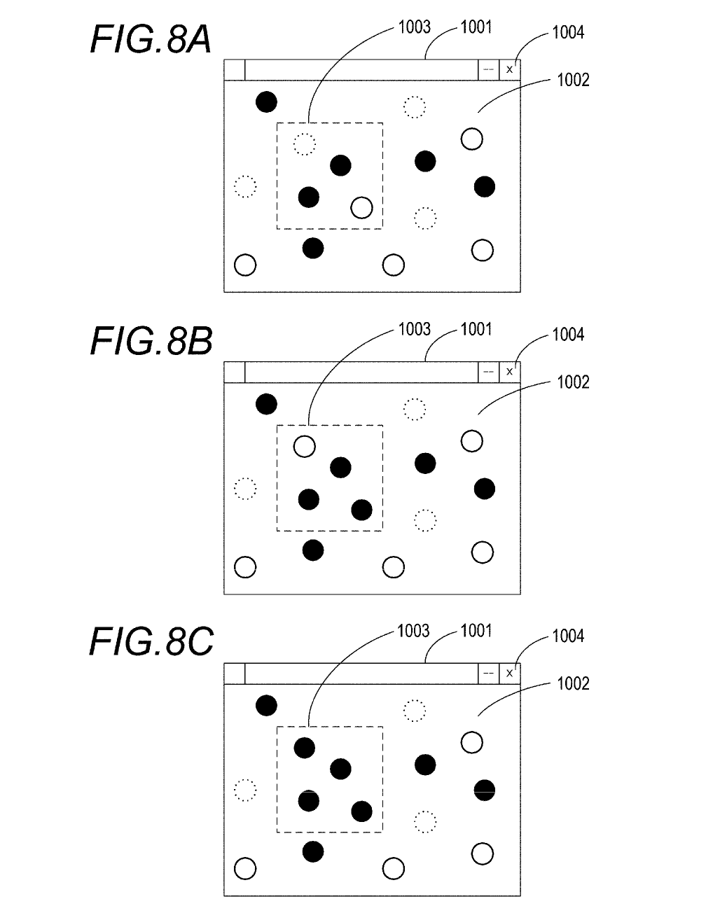

FIG. 5 illustrates a flow of main processing. Once the processing is started, in step S701, the image processing apparatus 102 displays a range designating screen on the display device 103. In the range designating screen, a range in the horizontal direction (XY direction) is designated as a target range to be used for the focus stacking processing. FIG. 8A illustrates an example of the range designating screen. The entirety of a layer image captured at a certain focal position is displayed in a region 1002 in an image display window 1001. The user is able to designate a position and size of a target range 1003 in the XY direction by dragging a mouse or by inputting values through a keyboard. It can be assumed, for example, that the user may designate, as the target range 1003, a portion in the specimen image displayed in the region 1002 that is determined necessary to observe in detail in a depth direction (Z direction). If the image as a whole should be observed in the depth direction, the entire range of the image should be designated. Reference numeral 1004 denotes an operation termination button. The image display window 1001 is closed by this button 1004 being pressed.

Once the range designation is completed, in step S702, the image processing apparatus 102 determines whether or not layer images have been captured at a necessary number of focal positions. If not, the image processing apparatus 102 transmits, in step S703, imaging parameters including imaging start position and end position, imaging pitch and so on to the imaging apparatus 101 to request the same to capture images. In step S704, the imaging apparatus 101 captures images at the focal positions according to the imaging parameters, and transmits a group of layer images thus obtained to the image processing apparatus 102. The images are stored in a storage device in the image processing apparatus 102.

Subsequently, the image processing apparatus 102 acquires a plurality of layer images to be subjected to the focus stacking processing from the storage device (step S705). The image processing apparatus 102 displays a focus stacking setting screen on the display device 103 to allow the user to designate parameters such as a focal position to be used as the reference position and a range of depth of field (step S706).

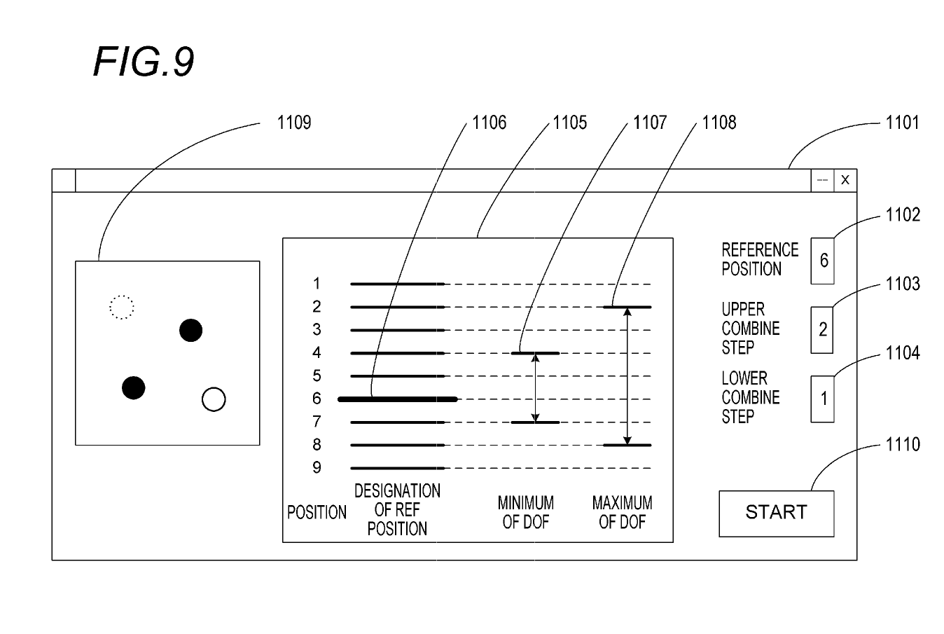

FIG. 9 shows an example of the setting screen. Reference numeral 1101 denotes a setting window. Reference numeral 1102 denotes an edit box for setting a focal position to be used as the reference position in the focus stacking processing. Reference numeral 1103 denotes an edit box for setting a number of steps of the combine range on the upper side of the reference position. Reference numeral 1104 denotes an edit box for setting a number of steps of the combine range on the lower side of the reference position. There is illustrated in FIG. 9 an example case in which the number of the upper composition steps is two, the number of the lower composition steps is one, the reference position is at six, and the total number of the focal positions is nine. During the focus stacking processing, the depth of field is varied by an integral multiple of a set step value. Specifically, in the setting example shown in FIG. 9, the minimum combine range is from the position 4 to the position 7, while the maximum combine range is from the position 2 to the position 8, and two focus-stacked images are generated.

Reference numeral 1105 denotes a region for graphically displaying a reference position and a combine range. In order to show the reference position designated in 1102, only a line 1106 indicating the reference position is emphasized by differing in width, length, color or the like from the other lines indicating the images (focal positions). Reference numeral 1107 denotes a minimum range of the depth of field (minimum combine range), while reference numeral 1108 denotes a maximum range of the depth of field (maximum combine range).

Reference numeral 1109 indicates an image at the reference position. In this example, only a partial image of the image at the focal position 6 residing in the target range designated in step S701 is displayed. The display of the partial image 1109 in this manner allows the user to designate parameters for the focus stacking processing while checking whether or not an item to be observed is contained in the target range and the extent of blurring of each item to be observed. Reference numeral 1110 denotes a combine processing start button.

It should be understood that FIG. 9 merely shows a specific example of the setting screen. Any other type of setting screen may be used as long as at least the reference position and the variation range of depth of field can be designated therein. For example, a pull-down list or combo box may be used in place of the edit box so that the reference position and step values can be selected. A method may be employed in which the reference position and the range of depth of field are designated by the user clicking a mouse on a GUI as shown in 1105.

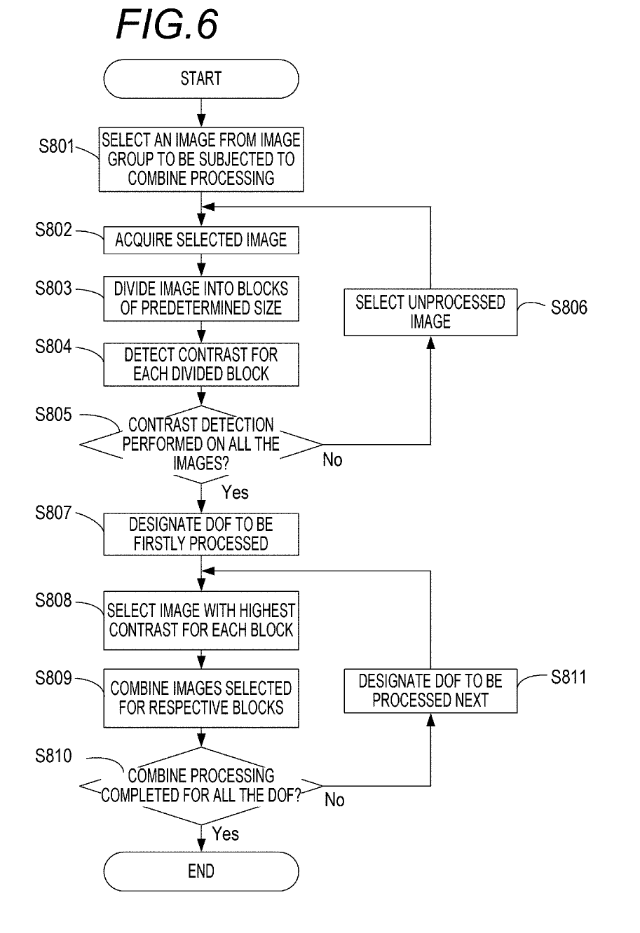

Once the user presses the combine processing start button 1110 after inputting the settings, the image processing apparatus 102 establishes the parameters set in the setting window 1101 and starts the combine processing of step S707. The flow of the combine processing will be described later in detail with reference to FIG. 6.

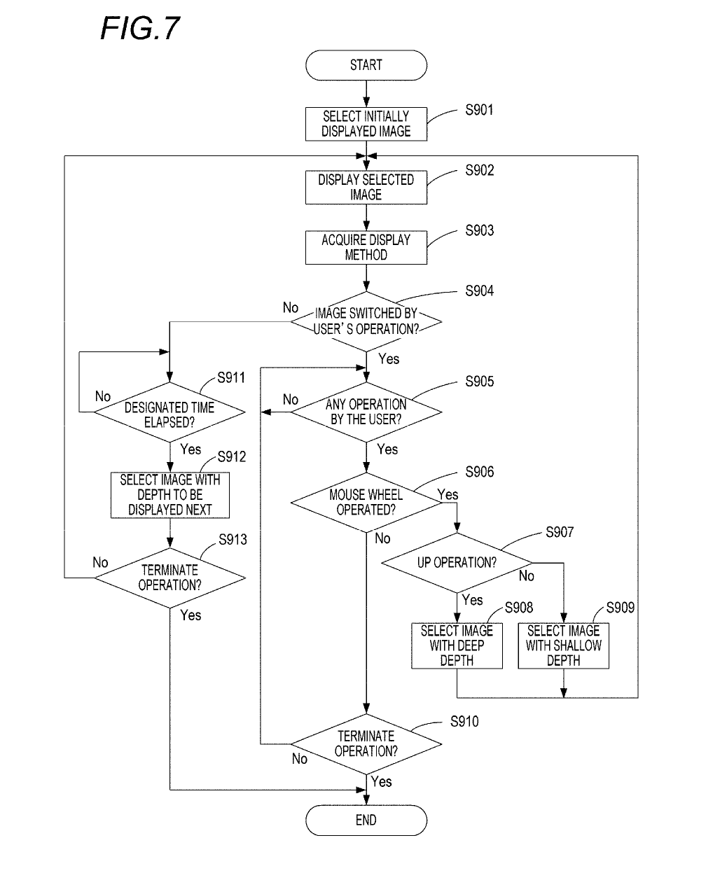

In step S708, the image processing apparatus 102 allows the user to designate a method of displaying the image after the combine processing. The display methods include a method of switching the displayed image by the user operating a mouse, a keyboard or the like (switching by the user) and a method of automatically switching the displayed image at predetermined time intervals (automatic switching), and the user is able to select either one. The time interval for switching in the case of automatic switching may be a predetermined fixed value, or may be designated by the use. In step S709, the image processing apparatus 102 performs display processing for the image after the combine processing by using the display method set in step S708. The flow of this display processing will be described later in detail with reference to FIG. 7.

Although in the example shown in FIG. 5, the setting for the focus stacking processing (step S706) is performed after the image acquisition (step S705), it may be performed, for example, directly after the range designation for the focus stacking processing (step S701). It is also possible to set parameters independently from the processing flow of FIG. 5, so that the image processing apparatus 102 retrieves the parameters stored in the storage device at necessary timings.

(Step S707: Combine Processing)

Referring to FIG. 6, the combine processing flow of step S707 will be described in detail.

The image processing apparatus 102 selects an arbitrary image from a group of images to be subjected to the combine processing in step S801. Subsequently, the image processing apparatus 102 retrieves the selected image from the storage device (step S802), divides the image into blocks with a predetermined size (step S803), and calculates a value indicating a contrast level for each of the blocks (step S804). This contrast detection processing may be particularly exemplified by a method in which discrete cosine transform is performed on each of the blocks to find a frequency component, a total sum of high-frequency components of the frequency components is obtained, and this total sum is employed as a value indicating a contrast level. In step S805, the image processing apparatus 102 determines whether or not the contrast detection processing has been performed on all of the images contained in the maximum combine range designated in step S706. If there are any images on which the contrast detection processing has not been performed, the image processing apparatus 102 selects these images as image to be processed next (step S806), and performs the processing steps S802 to S804. If it is determined in step S805 that the contrast detection processing has been done on all of the images, the processing proceeds to step S807.

The processing steps S807 to S811 are for generating a plurality of combined images having different depths of field. For example, in the example shown in FIG. 9, two combined images having the depths of field 1107 and 1108 are generated.

In step S807, the image processing apparatus 102 determines a depth of field for which the combine processing is to be performed in the first place. The image processing apparatus 102 then selects an image with the highest contrast from among a plurality of images contained in the determined depth of field for each of the blocks (step S808), and generates a single combined image by merging (joining) a plurality of partial images selected for the respective blocks (step S809). In step S810, the image processing apparatus 102 determines whether or not the combine processing has been completed for all of the designated depths of field. If there are any depths of field for which the combine processing has not been completed, the image processing apparatus 102 repeats the processing steps S808 and S809 for these depths of field (steps S810 and S811).

Although the above description has been made in terms of an example in which a contrast level is calculated based on spatial frequency, the processing in step S804 is not limited to this. For example, an edge detection filter may be used to detect an edge, and the obtained edge component may be used as the contrast level. Alternatively, a maximum and minimum values of brightness contained in the block are detected and a difference between the maximum and minimum values may be defined as the contrast level. Various other known methods can be employed for the detection of contrast.

(Step S709: Display Processing)

Next, the detail of the display processing flow of step S709 will be described with reference to FIG. 7.

The image processing apparatus 102 selects, in step S901, an image to be displayed in the first place. For example, an image with the shallowest or deepest depth of field may be selected as the image to be firstly displayed. The image processing apparatus 102 displays the selected image on the display device 103 (step S902), and retrieves the settings for the display method designated in step S708 described above (step S903). Although in the example shown in FIG. 7, the display method acquisition step S903 is performed after the step S902, the display method acquisition may be performed, for example, before the step S902 of displaying the selected image, in order to acquire the display method.

In step S904, the image processing apparatus 102 determines whether the designated display method is user switching (switching of the displayed image by the user's operation) or automatic switching. If the designated display method is user switching, the processing proceeds to step S905, whereas if it is automatic switching, the processing proceeds to step S911.

(1) User Switching

In step S905, the image processing apparatus 102 determines whether or not the user's operation has been done. If it is determined that the operation has not been done, the image processing apparatus 102 enters a standby state in step S905. If it is determined that the operation has been done, the image processing apparatus 102 determines whether or not a mouse wheel operation has been done (step S906). If it is determined that the wheel operation has been done, the image processing apparatus 102 determines whether the operation is UP operation or DOWN operation (step S907). If it is UP operation, image processing apparatus 102 switches the displayed image to the one with the next deeper depth of field (step S908). If it is DOWN operation, the image processing apparatus 102 switches the displayed image to the one with the next shallower depth of field (step S909). Although the description has been made in terms of an example in which the depth of field is switched step by step in response to the wheel operation, it is also possible to detect an amount of rotation of the mouse wheel per predetermined time and to change the amount of variation of depth of field according to the detected amount of rotation.

If it is determined in step S906 that an operation other than the mouse wheel operation has been done, the image processing apparatus 102 determines whether or not a termination operation has been done (step S910). If image processing apparatus 102 determines that the termination operation has been done, the apparatus 102 proceeds to step 905 and assumes a standby state.

(2) Automatic Switching

In the case of user switching, the displayed image is switched over according the user's operation. However, in the automatic switching, the displayed image is switched over automatically at intervals of predetermined time (denoted by t).

In step S911, the image processing apparatus 102 determines whether or not the predetermined time t has elapsed since the currently selected image has been displayed (step S902). If it is determined that the predetermined time t has not elapsed, the image processing apparatus 102 assumes a standby state in step S911. If it is determined that the predetermined time t has elapsed, the image processing apparatus 102 selects, step S912, an image with a depth of field to be displayed next. The processing then returns to step S902, and the displayed image is switched to another. This switching of display is continued until the user performs a termination operation (step S913).

The image selecting sequence can be determined by various methods. For example, images can be selected starting from the one with the shallowest depth of field and continuing to the ones with successively deeper depths of field. In this case, when the image with the deepest depth of field has been displayed and there is no more image to select, the display switching sequence may be looped back to the image with the shallowest depth of field that has been displayed in the first place. Alternatively, when there is no more image with a depth of field to select, the switching sequence may be inverted so that the displaying sequence is reciprocated between the image with the deepest depth of field and the image with the shallowest depth of field. Further, when there is no more image with a depth of field to select, the switching of the displayed image can be stopped to establish a standby state, and then the same display is started from the beginning according to an instruction given by the user clicking the mouse, for example. Further, the displayed images can be switched starting from the one with the deepest depth of field, and continuing to the ones with successively shallower depths of field. Many other displaying methods are applicable.

FIGS. 8A to 8C illustrate an example in which images with different depths of field are displayed. According to the present embodiment, images can be switch-displayed with use of the image display window 1001 that is used for the range designation. FIG. 8A shows an example of an image with the shallowest depth of field, that is, the image at the reference position 6 in FIG. 9. FIG. 8B shows an example of an image with the next shallowest depth of field, that is, the combined image generated from four images at the focal positions 4 to 7. FIG. 8C shows an example of an image with the third shallowest depth of field, that is, the combined image generated from seven images at the focal positions 2 to 8. It can be seen that the number of items to be observed in focus is increased in the sequence of FIG. 8A, FIG. 8B, and FIG. 8C. It should be noted that only the image portion within the region 1003 that has been designated as the range is switched in the sequence of the depths of field, whereas the other portion remains unchanged as the image at the reference position 6.

According to the configuration as described above, the user is enabled to very easily perform observation in which a portion of interest is focused while the condition of the peripheral portion is being changed. This enables the user to comprehend not only the two-dimensional structure but also the three-dimensional structure of the portion of interest (e.g. a tissue or cell). Further, since it is possible to designate (narrow down) a range in which the depth of field is varied, rapid processing can be performed even for a high-resolution and large-size image. Further, a portion with a deep depth of field (region 1003) and a portion with a shallow depth of field (the portion other than the region 1003) can be displayed together within a single displayed image, whereby it is made possible to realize a unique observation method of combining three-dimensional observation with two-dimensional observation, that was impossible with conventional optical microscopes.

### Second Embodiment

A second embodiment of this invention will be described. The description of the first embodiment has been made on the configuration for realizing the observation method in which the depth of field is varied while the focal position is kept fixed is described. However, in this second embodiment, a configuration for realizing an observation method in which the focal position is varied while the depth of field is kept fixed.

(System Configuration)

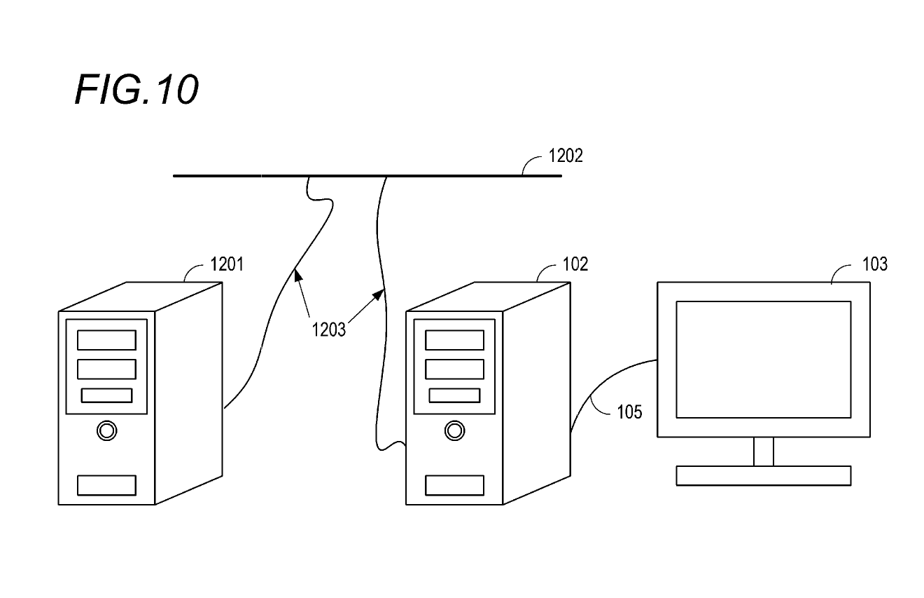

FIG. 10 is an overall view illustrating a layout of apparatuses in an image processing system according to the second embodiment.

The image processing system according to this second embodiment is composed of an image server 1201, an image processing apparatus 102, and a display device 103. The second embodiment is different from the first embodiment in that whereas the image processing apparatus 102 in the first embodiment acquires an image from the imaging apparatus 101, the image processing apparatus 102 in the second embodiment acquires an image from the image server 1201. The image server 1201 and the image processing apparatus 102 are connected to each other through general-purpose I/F LAN cables 1203 via a network 1202. The image server 1201 is a computer having a mass storage device for storing layer images captured by a virtual slide apparatus. The image processing apparatus 102 and the display device 103 are the same as those of the first embodiment.

Although in the example shown in FIG. 10, the image processing system is composed of three components: the image server 1201, the image processing apparatus 102 and the display device 103, the configuration of this invention is not limited to this. For example, an image processing apparatus having an integrated display device may be used, or the functions of the image processing apparatus may be integrated into the image server. Further, the functions of the image server, the image processing apparatus and the display device can be realized by a single apparatus. Alternatively and inversely, the functions of the image server and/or the image processing apparatus can be divided so that they are realized by a plurality of apparatuses or devices.

(Processing to Change Focal Position with Fixed Depth of Field)

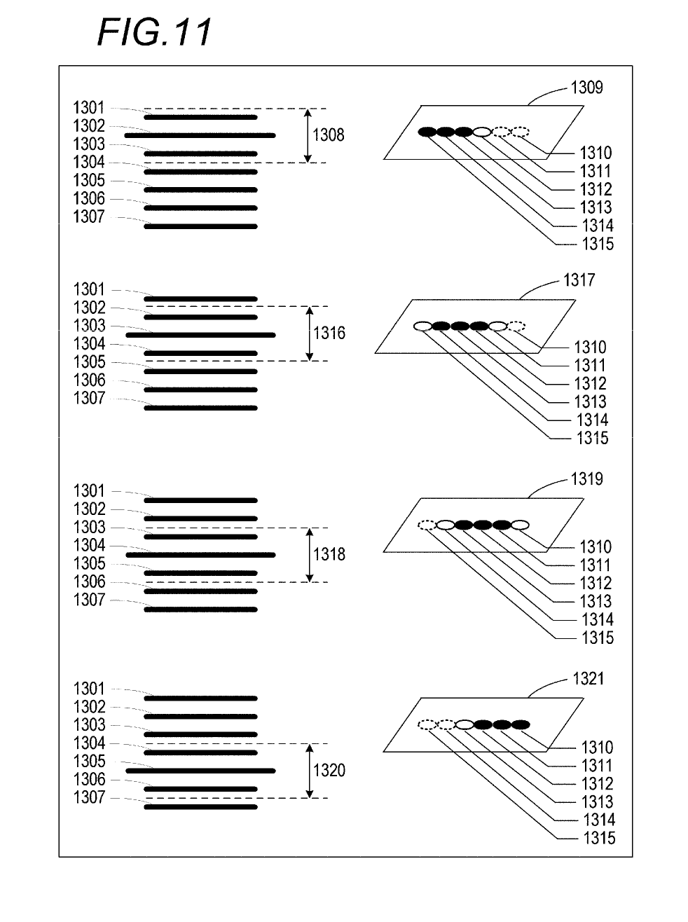

FIG. 11 is a conceptual diagram illustrating a method of realizing an observation method with use of a virtual slide apparatus wherein the focal position (actually, the focus stacking reference position) is varied while the depth of field is kept fixed. Referring to FIG. 11, basic concept of focus stacking processing which characterizes the present embodiment will be described.

Focal positions 1301 to 1307 correspond to the images 501 to 507 in FIG. 3, respectively. The focal position is shifted at the same pitch from 1301 to 1307 in an optical axis direction. The following description will be made in terms of an example in which a combined image having depths of field corresponding to three images is generated by the focus stacking processing.

An image 1309 is a combined image generated by the focus stacking processing when the reference position is set to 1302 and the depth of field is set to 1308. In the image 1309, three regions 1313, 1314, and 1315 are in focus.

An image 1317 is a combined image generated by the focus stacking processing when the reference position is set to 1303 and the depth of field is set to 1316. The image 1317 has the same depth of field as the image 1309, but is different from the image 1309 in focal position to be used as the reference. As a result, the image 1317 and the image 1309 are different from each other in the positions of the regions which are in focus. In the image 1317, the region 1315 which is in focus in the image 1309 is not in focus any more, whereas the region 1312 which is not in focus in the image 1309 is in focus.

An image 1319 is a combined image generated by the focus stacking processing when the reference position is set to 1304, and the depth of field is set to 1318. An image 1321 is a combined image generated by the focus stacking processing when the reference position is set to 1305 and the depth of field is set to 1320. In the image 1319, regions 1311 to 1313 are in focus, while in the image 1321, regions 1310 to 1312 are in focus.

These combined images 1309, 1317, 1319 and 1321 are generated and displayed while being switched automatically or by the user's operation, which enables observation at a deeper depth of field than the original image while changing the focal position.

A microscope apparatus typically has a shallow depth of field and hence an image will be out of focus even if it is deviated even slightly from the focal position in the optical axis direction. Therefore, observation becomes difficult if a region of interest extends to a certain degree in a depth direction. However, when the depth of field is enlarged to a desired depth by the inventive method described above, only a single displayed image makes it possible to observe the entire region of interest that is in focus. Further, when images are successively viewed while the focal position is shifted in the optical axis direction, the object will be easily out of focus even by slight shift of the focal position if the depth of field is shallow, and thus the association between the images adjacent in the depth direction is apt to be lost. However, according to the inventive method described above, the ranges of the depths of field of the combined images overlap with each other, the change in focus state caused by switching of the images becomes gradual, which makes it easy to comprehend the association between the images adjacent in the depth direction. Furthermore, when the enlargement of the depth of field is limited to the desired depth, blur will remain in the periphery of the object of interest. If the blur remains in the periphery of the object of interest, it will give the user a sense of depth, and the user is allowed to view the image while feeling the stereoscopic effect in the object of interest.

FIG. 11 illustrates an example in which the number of images used in combine processing (number of images contained in the range of depth of field) is the same as the number of regions which are in focus, and both the numbers are three. However, these numbers generally do not necessarily match and the number of regions in focus varies from one reference position to another. Further, although FIG. 11 illustrates an example in which regions in focus are varied such that they are shifted to adjacent regions, actual results are not limited to this. For example, the state of the regions in focus differs according to the condition of the object, the focal position when the image is captured, or the depth of field to be set.

(Operation of Image Processing Apparatus)

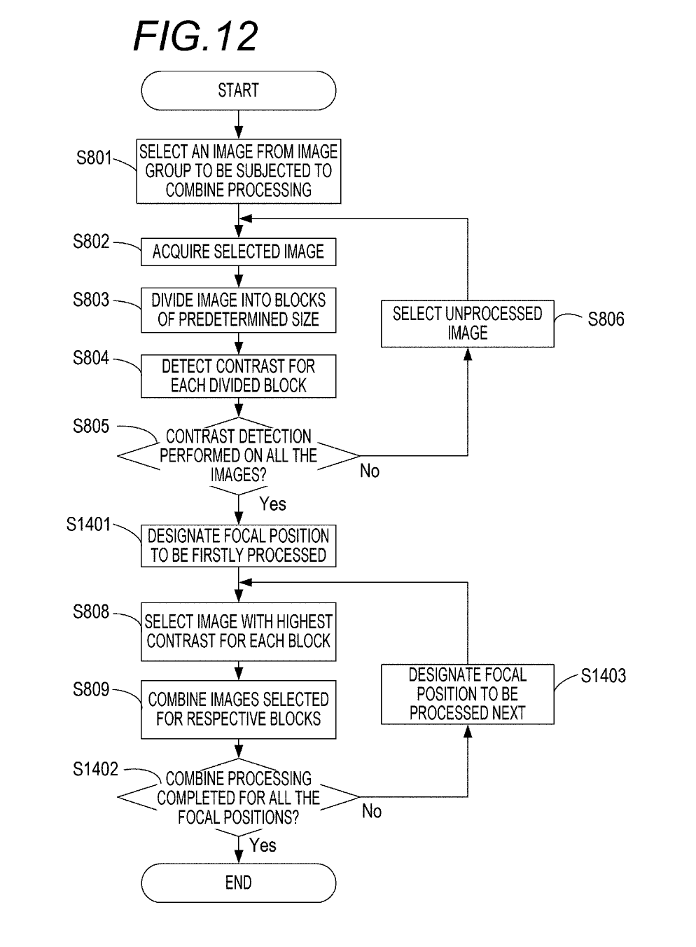

Operation of the image processing apparatus 102 according to the second embodiment will be described with reference to FIGS. 12 to 14. Flow of the main processing is the same as that of FIG. 5 described in the first embodiment. However, in this embodiment, the determination in step S702 of FIG. 5 is replaced with determination whether or not a captured image exists in the image server 1201. In addition, the destination to store the images in step S704 is replaced with the image server 1201. Different points from the processing of the first embodiment will be described in detail.

(S706: Setting for Focus Stacking Processing)

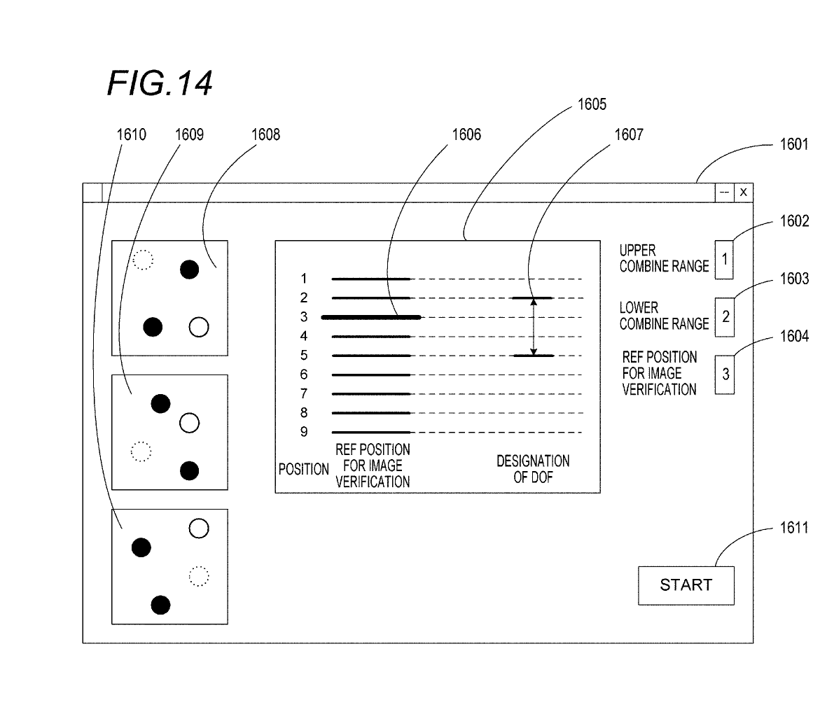

FIG. 14 illustrates an example of a setting screen for setting parameters for the focus stacking processing according to the second embodiment.

Reference numeral 1601 indicates a setting window. Reference numeral 1602 indicates an edit box for setting an upper focus stacking range on the upper side of the reference position. Reference numeral 1603 denotes an edit box for setting a lower focus stacking range on the lower side of the reference position. Reference numeral 1604 denotes an edit box for setting reference position for images (1608 to 1610) to be displayed for verification. FIG. 14 shows an example in which the upper focus stacking range is 1, the lower stacking range is 2, and the reference position for verification of the image is at 3. In this case, a combined image is generated from four images including the image at the reference position.

Reference numeral 1605 denotes a region in which the contents designated in 1602 to 1604 are graphically displayed. The reference position for image verification is displayed in emphasis by using a line 1606 having a different width, length and color from those of the other lines indicating the other images (focal positions) so that the reference position for image verification is distinguished easily. Reference numeral 1607 indicates a range of depth of field when the focal position 3 is used as the reference.

The images 1608, 1609 and 1610 displayed for verification are images at the focal positions 2, 3 and 5, respectively. A region within the range designated in step S701 is displayed in each of the images. The display of these images for verification makes it possible to designate a combine range while checking whether or not the entire object of interest is in focus.

It should be noted that FIG. 14 merely shows a specific example of the setting screen, and any other type of setting screen may be used as long as a combine range can be designated on it. For example, the setting screen may be such that a combine range or the like can be selected by means of a pull-down list or combo box instead of the edit box. Alternatively, a method may be used in which a combine range or the like is designated on a GUI ad indicated by 1605 by the user clicking a mouse.

Once a combine processing start button 1611 is pressed by the user after the settings are input, the image processing apparatus 102 establishes the parameters set in the setting window 1601, and starts the combine processing of step S707.

(Step S707: Synthesis Processing)

FIG. 12 illustrates a flow of the combine processing shown in FIG. 11, and illustrates detailed contents of the processing in step S707 according to the present embodiment. FIG. 12 corresponds to FIG. 6 which illustrates the detailed flow of the combine processing according to the first embodiment. Like items are assigned with like reference numerals and description thereof will be omitted.

Processing steps from step S801 to step S806 are performed in the same manner as in the first embodiment. In step S1401, the image processing apparatus 102 determines a focal position (reference position) for which the combine processing is performed in the first place, and generates a combined image in the same manner as in the first embodiment (steps S808 and S809). In step S1402, the image processing apparatus 102 determines whether or not the combine processing has been completed for all the designated focal positions, and if there are any focal positions for which the combine processing has not been performed, the processing steps of steps S808 and S809 are repeated (step S1403).

In the description above, the combine processing is performed for all the focal positions in step S1402. However, when the combine processing is to be performed for all the focal positions, a case may occur in which images required for the combine processing become short at the uppermost or lowermost focal position, and the combine processing cannot be performed in the designated range of depth of field. Therefore, the setting may be such that the combine processing is performed only for the images at the focal positions that can be subjected to the combine processing in the range of the designated range of depth of field. Alternatively, various other methods can be applied. For example, the range of focal position for which the combine processing is to be performed can be designated by the user.

(Step S709: Display Processing)

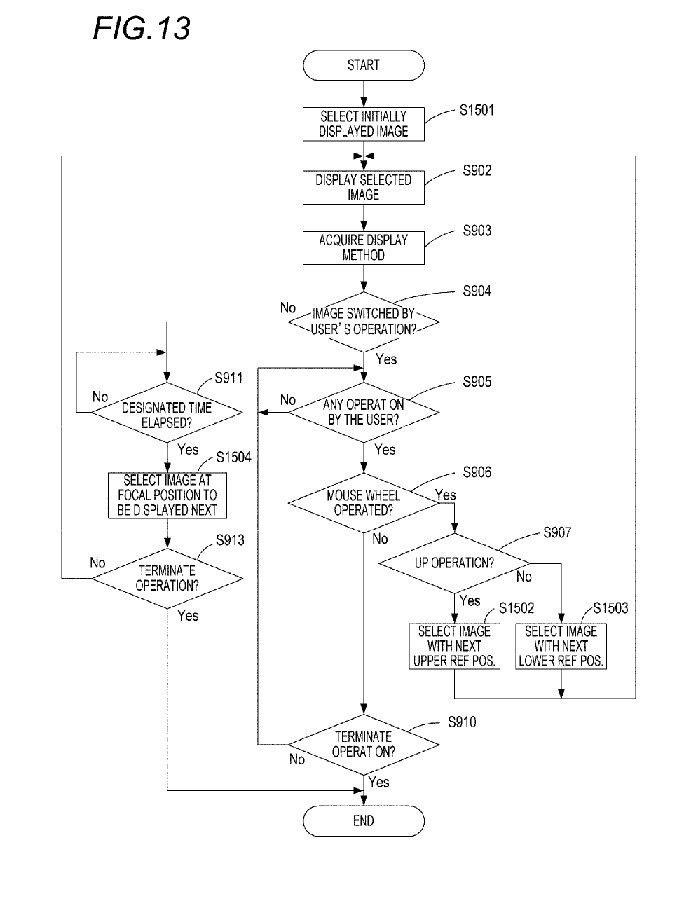

FIG. 13 shows a detailed flow of image display processing according to the second embodiment. FIG. 13 corresponds to FIG. 7 illustrating the detailed flow of the image display processing according to the first embodiment. Like items are assigned with like reference numerals and description thereof will be omitted.

The image processing apparatus 102 selects, in step S1501, an image to be displayed in the first place. For example, an image whose focal position is closest to that of the entire image, or an image whose focal position is farthest from that of the entire image is selected as an image to be displayed in the first place. Then, the selected image is displayed in the same manner as in the first embodiment, and the user switching or automatic switching is performed according to a designated display method. In the first embodiment, the depth of field is enlarged or reduced by UP/DOWN of the mouse wheel when the user switching is designated. In contrast, in this second embodiment, the reference position is shifted upwards by UP (step S1502), and the reference position is shifted downward by DOWN (step S1503). When the automatic switching is designated, the depth of field is switched in the first embodiment, whereas the reference position is shifted upward or downward sequentially in the second embodiment (step S1504). The other features of the processing are the same as those in the first embodiment.

According to the configuration described above, it is made possible to observe a plurality of combined images obtained by performing the focus stacking at a desired depth of field at a plurality of focal positions. The user is allowed to observe a plurality of combined images whose range of depth of field has been enlarged, and thus allowed to comprehend the structure of the specimen in its depth direction (Z direction) more easily than when a plurality of original images (layer images) are directly observed.

### Third Embodiment

A third embodiment of this invention will be described. One of characteristics of the image processing apparatus 102 according to the embodiment resides in that a combined image can be obtained by selectively performing the combine methods described in the embodiments above. Another characteristic of the image processing apparatus 102 according to the third embodiment is that the display method described in the embodiments above and other display method to be described later are selectively performed. Description will be made focusing on these points.

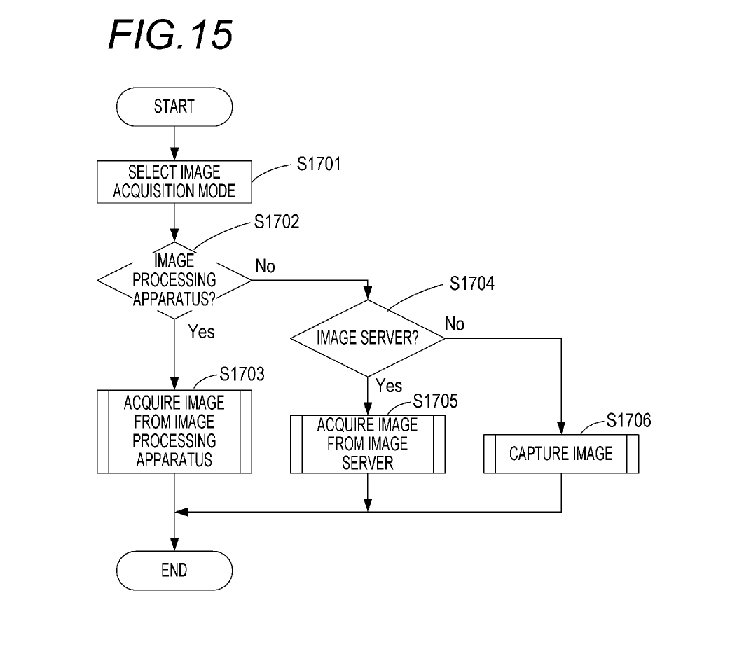

FIG. 15 is flowchart illustrating a flow of image acquisition according to this third embodiment. In step S1701, the image processing apparatus 102 allows the user to select an image acquisition mode. The image can be acquired by selecting any of a local storage device in the image processing apparatus 102, the image server 1201, and the imaging apparatus 101 as the source of acquisition of the image.

When the local storage device is selected (Yes in step S1702), the image processing apparatus 102 acquires a necessary image from its own storage device, and terminates the processing (step S1703). When the image server 1201 is selected (Yes in step S1704), the image processing apparatus 102 acquires a necessary image from the image server 1201 via the network, and terminates the processing (step S1705). When the imaging apparatus 101 is selected (No in step S1704), the image processing apparatus 102 transmits imaging parameters and an imaging request to the imaging apparatus 101 to cause the same to perform imaging and acquires the image thus captured (step S1706).

It should be noted that the image acquisition method is not limited to the one illustrated in FIG. 15. For example, options for the source for image acquisition may be two of the image processing apparatus 102, the image server 1201, and the imaging apparatus 101. Further, the source for image acquisition can be selected from more options including a storage connected through a dedicated line, a recording medium such as a memory card, another computer, and another virtual slide system.

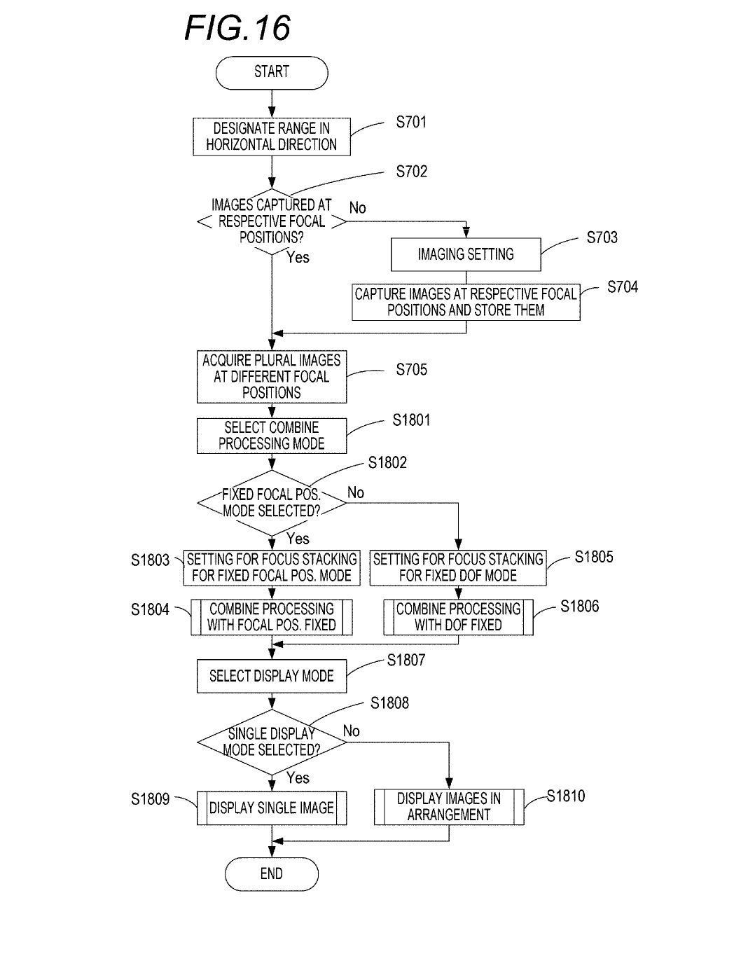

A flow of processing according to the present embodiment will be described with reference to FIG. 16. Like items to those of the afore-mentioned processing flow shown in FIG. 5 are assigned with like reference numerals, and the description thereof will be omitted.

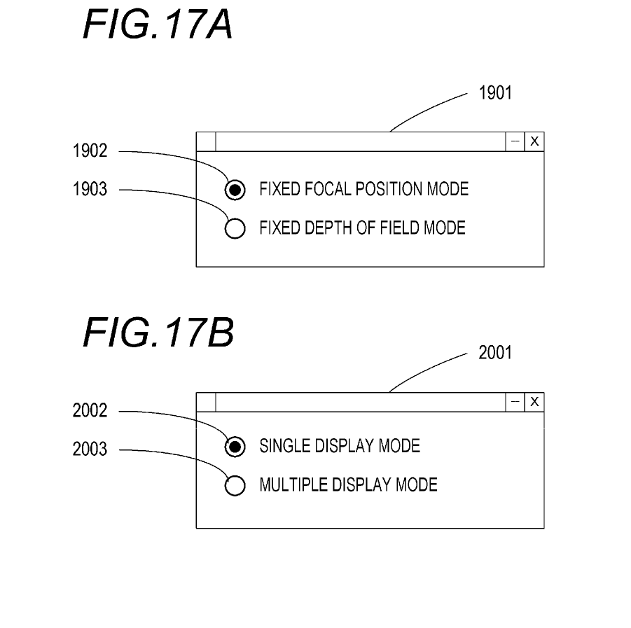

Processing steps of steps S701 to S705 are performed in the same manner as in the foregoing embodiments. In step S1801, the image processing apparatus 102 displays a combine processing mode designating screen 1901 shown in FIG. 17A, and allows the user to select a combine processing mode. The combine processing mode can be selected from either the fixed focal position mode 1902 described in the first embodiment or the fixed depth of field mode 1903 described in the second embodiment.

In step S1802, the processing is branched according to a result of selection in step S1801, and when the fixed focal position mode is selected, the processing proceeds to step S1803. The image processing apparatus 102 displays the setting screen shown in FIG. 9 and allows the user to do setting for the focus stacking processing for the fixed focal position mode (step S1803). Subsequently, the image processing apparatus 102 performs the combine processing with the focal position fixed (step S1804). In contrast, when the fixed depth of field mode is selected, the image processing apparatus 102 displays the setting screen shown in FIG. 14, allows the user to do setting for the focus stacking processing for the fixed depth of field mode (step S1805), and then performs the combine processing with the depth of field fixed (step S1806).

Next, in step S1807, the image processing apparatus 102 displays a display mode designating screen 2001 shown in FIG. 17B to allow the user to designate a display mode. The display mode can be selected from either a single display mode 2002 or a multiple display mode 2003.

When the single display mode is selected (Yes in step S1808), the image processing apparatus 102 displays a plurality of combined images one by one while switching them successively in time division, as shown in FIGS. 8A to 8C (step S1809). When the multiple display mode is selected (No in step S1808), the image processing apparatus 102 performs display in the multiple display mode (step S1810).

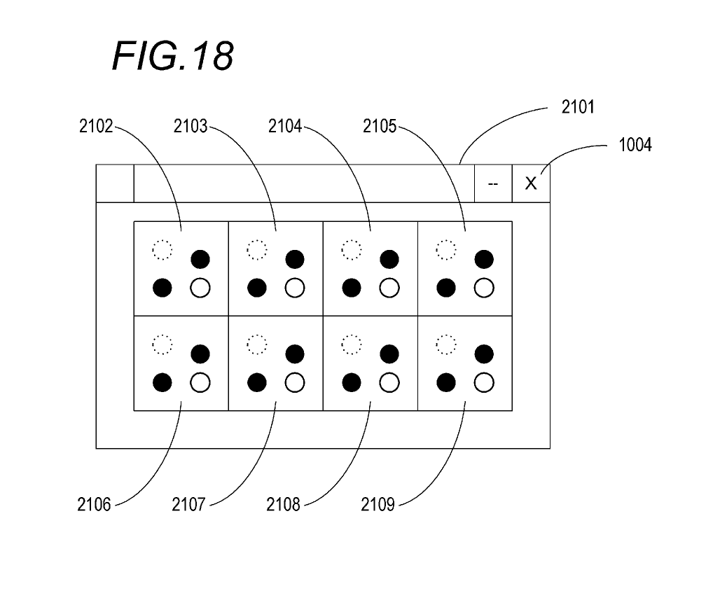

FIG. 18 shows an example of a screen displayed in the multiple display mode in step S1810. There are displayed in an image display window 2101 a plurality of combined images 2102 to 2109 arranged spatially. The display method in the multiple display mode is not limited to the example shown in FIG. 18. For example, the method may be such that some of the plurality of images, instead of all the images, are displayed in arrangement within the image display window and the displayed images are switched sequentially by means of a mouse scroll operation or the like. Any other method may be employed as long as at least two or more images are displayed simultaneously at different positions in the multiple display mode so that the user can compare a plurality of images.

The combine processing mode can be selected by a method other than those described above. For example, the image processing apparatus 102 displays the screen of FIG. 17A at the start-up of the program or the like to allow the user to select a combine processing mode, and retrieves, in step S1802, the selected one which has been stored. Further, instead of providing a window as shown in FIG. 17A exclusively used for mode selection, a UI for selecting a combine processing mode may be provided in the combine processing setting screen shown in FIG. 9 and FIG. 14.

Likewise, the display mode also may be selected by a method other than those described above. For example, the image processing apparatus 102 displays the screen of FIG. 17B at the start-up of the program or the like to allow the user to select a display mode, and retrieves, in step S1808, the selected one which has been stored. Further, instead of providing a window as shown in FIG. 17B exclusively used for mode selection, a UI for selecting a display mode may be provided in the image display screen shown in FIG. 8 and FIG. 18.

Although the present embodiment has been described in terms of an example in which the combine processing mode and the display mode are changeable bidirectionally, it is not limited to this. For example, these modes may be changeable only in one direction. Further, in terms of the selection of the combine processing mode, options may be included for switching to other image processing modes. Likewise, in terms of the selection of the display mode, options may be included for switching to other display modes. Other displays modes include, for example, a display mode in which only original images (layer images) which have not been subjected to the focus stacking processing are displayed, and a display mode in which an image which has been subjected to the focus stacking processing and an image which has not been subjected to the focus stacking processing are both displayed such that they can be compared. The provision of the display mode for displaying an image subjected to the focus stacking processing and an image not subjected to the focus stacking processing so as to be comparable each other makes it possible to comprehend the condition of a region, which has been cut out from another image and synthesized by the focus stacking processing, when it was originally imaged. This makes it possible to view the image while comparing the one in its clear condition and the one in the condition having a sense of depth.

The configuration described above makes it possible to combine images imaged at a plurality of focal positions by a desired method. Further, it is also made possible to display the combined images by a desired method. As a result, the user is able to obtain an optimum combine and display result according to the imaged result of the object by selectively switching the combine processing modes and display modes.

### Other Embodiments

The described embodiments represent only specific examples of this invention, and the configuration of the invention is not limited to these specific examples.

For example, although in the first and second embodiments, the user switching and the automatic switching are the selectable options, the display method may be only one of them. Also, the user switching and the automatic switching can be combined together. Further, it is also possible to perform combine processing on the entire region displayed at 1002 of FIG. 8A without designating the range, and to display the image of this combine-processed region. Further, the images to be displayed while being switched may include not only images after combine processing but also images before combine processing captured at respective focal positions (layer images). In this case, the options provided to be selected may include a mode for displaying only images obtained as a result of combine processing, a mode for displaying only images before combine processing, and a mode for displaying all the images including those obtained as a result of combine processing and those before combine processing.

Although in the aforementioned embodiments, the processing flow is shown in which parameters such as variation range of depth of field and reference position are designated, the invention is not limited to this. For example, preset parameters can be stored so that the stored parameters are retrieved when the range (1003) is designated or the program is started up. This eliminates the need of displaying the setting screen shown in FIG. 9 or FIG. 14, and enables observation of a desired image only by operation on the image display screen shown in FIG. 8A.

Further, although the description of the first and second embodiments has been made in terms of an example of processing in which one of focal position and depth of field is varied while the other is fixed, this invention is not limited to this. For example, it is also possible to generate combined images by varying both focal position and the depth of field, so that these combined images can be switch-displayed. In this case, three modes can be selected, namely a fixed focus/variable depth-of-field mode, a fixed depth-of-field/variable focus mode, and variable focus/variable depth-of-field mode.

Still further, the configurations described in the first to third embodiments can be combined with each other. For example, the image combine processing and image display processing according to the second embodiment can be performed in the system configuration of the first embodiment and, inversely, the image combine processing and image display processing according to the first embodiment can be performed in the system configuration of the second embodiment. Various other configurations obtained by combining various techniques according to the aforementioned embodiments also fall within the scope of this invention.

Although in the aforementioned embodiments, the image switching is instructed by mouse wheel operation, the image switching also can be instructed by scroll operation of a pointing device such as a trackpad, a trackball, or a joystick. Further, the instruction can be also given by means of a predetermined key of a keyboard (e.g. vertical shift key or page UP/DOWN key).

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-074603, filed on Mar. 30, 2011, which is hereby incorporated by reference herein in its entirety.

1. An image processing apparatus comprising:
an image acquisition unit for acquiring a plurality of layer images obtained by imaging different Z-direction positions of an object using a microscope apparatus;
an image generation unit for generating a plurality of observation images from the plurality of layer images, the observation images being mutually different in at least either focal position or depth of field; and
an image displaying unit for displaying the observation images on a display device,
wherein:
the image generation unit generates the plurality of observation images by performing combine processing for two or more layer images of the plurality of layer images and focus-stacking the two or more layer images to generate a single observation image, for a plurality of times; and
the image displaying unit selects the observation images to be displayed, when the observation images displayed on the display device are switched, such that the focal position or the depth of field changes sequentially.

2. The image processing apparatus according to claim 1, wherein the image generation unit generates the plurality of observation images such that the plurality of observation images have mutually different depths of field.

3. The image processing apparatus according to claim 1, wherein the image generation unit generates the plurality of observation images such that the plurality of observation images have mutually different focal positions.

4. The image processing apparatus according to claim 1, further comprising a range designation unit for allowing a user to designate a target range on which the combine processing is to be performed in the layer image,
wherein the image generation unit generates an observation image only for the portion of the image within the target range designated by the range designation unit.

5. The image processing apparatus according to claim 4, wherein the image displaying unit displays, on the display device, an image in which the observation image is incorporated into the portion of the target range in the layer image.

6.-7. (canceled)

8. The image processing apparatus according to claim 1, further comprising a mode designation unit for allowing a user to designate a display mode to be used from a plurality of display modes including a mode for displaying a plurality of images sequentially in time division and a mode for displaying a plurality of images arranged spatially,
wherein the image displaying unit displays the plurality of observation images according to the display mode designated by the mode designation unit.

9. An image processing apparatus comprising:
an image acquisition unit for acquiring a plurality of layer images obtained by imaging different Z-direction positions of an object using a microscope apparatus; and
an image generation unit for generating a plurality of observation images from the plurality of layer images,
wherein the image generation unit generates observation images having mutually different depths of field, by performing combine processing for two or more layer images of the plurality of layer images and focus-stacking the two or more layer images to generate a single observation image, for a plurality of times.

10. An imaging system comprising:
a microscope apparatus for generating a plurality of layer images by imaging different Z-direction positions of an object; and
the image processing apparatus according to claim 1, for acquiring the plurality of layer images from the microscope apparatus.

11. An image processing system comprising:
a server for storing a plurality of layer images obtained by imaging different Z-direction positions of an object using a microscope apparatus; and
the image processing apparatus according to claim 1, for acquiring the plurality of layer images from the server.

12. A computer program stored on a non-transitory computer readable medium, the program causing a computer to perform a method comprising the steps of:
acquiring a plurality of layer images obtained by imaging different Z-direction positions of an object using a microscope apparatus;
generating a plurality of observation images from the plurality of layer images, the observation images being mutually different in at least either focal position or depth of field; and
displaying the observation images on a display device,
wherein:
in the step of generating the observation images, the plurality of observation images are generated by performing combine processing for two or more layer images of the plurality of layer images and focus-stacking the two or more layer images to generate a single observation image, for a plurality of times; and
in the step of displaying the observation images, the observation images to be displayed are selected, when the observation images are switched, such that the focal position or the depth of field changes sequentially.

13. A computer program stored on a non-transitory computer readable medium, the program causing a computer to perform a method comprising the steps of:
acquiring a plurality of layer images obtained by imaging different Z-direction positions of an object using a microscope apparatus; and
generating a plurality of observation images from the plurality of layer images,
wherein:
in the step of generating the observation images, observation images having mutually different depths of field are generated by performing combine processing for two or more layer images of the plurality of layer images and focus-stacking the two or more layer images to generate a single observation image, for a plurality of times.

14. The image processing apparatus according to claim 9, wherein the plurality of observation images are generated such that a range in focus in Z-direction of an observation image with a relatively deeper depth of field includes a range in focus in Z-direction of an observation image with a relatively shallower depth of field.

15. The image processing apparatus according to claim 9, wherein the plurality of observation images include a first observation image and a second observation image with a deeper depth of field than the first observation image, and
the second observation image is generated such that a range in focus in Z-direction of the second observation image includes a range in focus in Z-direction of the first observation image and is expanded toward at least one side in Z-direction from the range in focus in Z-direction of the first observation image.

16. The image processing apparatus according to claim 15, wherein the second observation image is generated by combining, at least, first layer images selected for generation of the first observation image and a second layer image, the second layer image being adjacent to the first layer images in Z-direction with respect to the Z-direction position of the object.

17. The image processing apparatus according to claim 15, wherein the second observation image is generated such that the range in focus in Z-direction of the second observation image is expanded toward only one side in Z-direction from the range in focus in Z-direction of the first observation image.

18. The image processing apparatus according to claim 15, wherein the second observation image is generated such that the range in focus in Z-direction of the second observation image is expanded to different extents between one side and the other side in Z-direction from the range in focus in Z-direction of the first observation image.

19. The image processing apparatus according to claim 15, wherein the second observation image is generated such that the range in focus in Z-direction of the second observation image is expanded to an equal extent toward both sides in Z-direction from the range in focus in Z-direction of the first observation image.

20. An imaging system comprising:
a microscope apparatus for generating a plurality of layer images by imaging different Z-direction positions of an object; and
the image processing apparatus according to claim 9, for acquiring the plurality of layer images from the microscope apparatus.

21. An image processing system comprising:
a server for storing a plurality of layer images obtained by imaging different Z-direction positions of an object using a microscope apparatus; and
the image processing apparatus according to claim 9, for acquiring the plurality of layer images from the server.
